(19) United States
(12) Patent Application Publication
(10) Pub. No.: US 2002/0031101 A1
(43) Pub. Date: Mar. 14, 2002

(54) System and methods for interconnecting remote devices in an automated monitoring system

(76) Inventors: Thomas D. Petite, Douglasville, GA (US); James Davis, Woodstock, GA (US); David Philip Aldoretta, Duluth, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/925,445

(22) Filed: Aug. 9, 2001

Related U.S. Application Data
(63) Continuation-in-part of application No. 09/704,150, filed on Nov. 1, 2000.

(51) Int. Cl. H04B 7/00

(52) U.S. Cl. 370/310; 379/49

(57) ABSTRACT

The present invention may be viewed as providing a system for interconnecting a plurality of remote devices to a site controller in an automated monitoring system via a wireless communication network. The automated monitoring system may be configured for monitoring and controlling the plurality of remote devices using a host computer adapted to communicate with the site controller via a communication network. Briefly described, in one embodiment, the system comprises a plurality of transceivers and a plurality of repeaters. Each of the plurality of transceivers have a unique identifier. Furthermore, each of the plurality of transceivers may be configured for communication with one of the plurality of remote devices and configured to receive a sensor data signal from the corresponding remote device and provide a data message over the wireless communication network using a predefined communication protocol. The data message may comprise the unique identifier corresponding to the transceiver sending the message, as well as the sensor data signal. The plurality of repeaters also have unique identifiers. Each of the plurality of repeaters may be disposed in relation to the plurality of transceivers such that each of the plurality of repeaters is in communication with at least one of the plurality of transceivers via the wireless communication network. Furthermore, each of the plurality of repeaters may be configured to receive the data message from the corresponding transceiver and provide an outgoing data message over the wireless communication network using the predefined communication protocol. The outgoing data message may include the data message received from the corresponding transceiver and the corresponding unique identifier for the repeater.

### CROSS-REFERENCE TO RELATED APPLICATIONS

This application is a continuation-in-part of U.S. patent application Ser. No. 09/704,150, filed Nov. 1, 2000, and entitled, “System and Method for Monitoring and Controlling Residential Devices;” U.S. patent application Ser. No. 09/271,517; filed Mar. 18, 1999, and entitled, “System For Monitoring Conditions in a Residential Living Community;” U.S. patent application Ser. No. 09/439,059, filed Nov. 12, 1999, and entitled, “System and Method for Monitoring and Controlling Remote Devices;” and U.S. patent application Ser. No. 09/102,178, filed Jun. 22, 1998, and entitled, “Multi-Function General Purpose Transceiver.” Each of the identified U.S. Patent Applications is incorporated herein by reference in its entirety. This application also claims the benefit of U.S. Provisional Application Serial No. 60/223,923, filed Aug. 9, 2000, and entitled “Design Specifications for a Repeater Function,” which is hereby incorporated by reference in its entirety.

### FIELD OF THE INVENTION

The present invention generally relates to systems for monitoring and/or controlling a plurality of remote devices via a host computer connected to a communication network, and more particularly to systems and methods for interconnecting the remote devices.

### BACKGROUND

There are a variety of systems for monitoring and/or controlling any of a number of systems and/or processes, such as, for example, manufacturing processes, inventory systems, emergency control systems, personal security systems, residential systems, and electric utility meters to name a few. In many of these “automated monitoring system,” a host computer in communication with a communication network, such as a wide area network, monitors and/or controls a plurality of remote devices arranged within a geographical region. The plurality of remote devices typically use remote sensors and actuators to monitor and automatically respond to various system parameters to reach desired results. A number of automated monitoring systems utilize computers to process sensor outputs, to model system responses, and to control actuators that implement process corrections within the system.

For example, both the electric power generation and metallurgical processing industries successfully control production processes by implementing computer control systems in individual plants. Home security has been greatly increased due to automated monitoring devices. Many environmental and safety systems require real-time monitoring. Heating, ventilation, and air-conditioning systems (HVAC), fire reporting and suppression systems, alarm systems, and access control systems utilize real-time monitoring and often require immediate feedback and control.

A problem with expanding the use of automated monitoring systems is the cost of the sensor/actuator infrastructure required to monitor and control such systems. The typical approach to implementing automated monitoring system technology includes installing a local network of hard-wired sensor(s)/actuator(s) and a site controller. There are expenses associated with developing and installing the appropriate sensor(s)/actuator(s) and connecting functional sensor(s)/actuator(s) with the site controller. Another prohibitive cost of control systems is the installation and operational expenses associated with the site controller.

Another problem with using automated monitoring system technology is the geographic size of automated monitoring systems. In a hard-wired automated monitoring system, the geographic size of the system may require large amounts of wiring. In a wireless automated monitoring system, the geographic size of the automated monitoring system may require wireless transmissions at unacceptable power levels.

Accordingly, there is a need for automated monitoring systems that overcome the shortcomings of the prior art.

### SUMMARY OF THE INVENTION

The present invention is generally directed to a cost-effective automated monitoring system and method for monitoring and controlling a plurality of remote devices via a host computer connected to a communication network, such as a wide area network. The automated monitoring system may include one or more sensors to be read and/or actuators to be controlled, ultimately, through a remote applications server via a site controller. The remote applications server and the site controller may communicate via a communication network, such as a wide area network. The sensors and/or actuators are in communication with communication devices, which may be wireless, that transmit and/or receive encoded data and control signals to and from the site controller. The automated monitoring system also includes a plurality of signal repeaters that may relay information between the communication devices disposed in connection with the sensors and/or actuators and the site controller.

The present invention may be viewed as providing a system for interconnecting a plurality of remote devices to a site controller in an automated monitoring system via a wireless communication network. The automated monitoring system may be configured for monitoring and controlling the plurality of remote devices using a host computer adapted to communicate with the site controller via a communication network. Briefly described, in one embodiment, the system comprises a plurality of transceivers and a plurality of repeaters. Each of the plurality of transceivers have a unique identifier. Furthermore, each of the plurality of transceivers may be configured for communication with one of the plurality of remote devices and configured to receive a sensor data signal from the corresponding remote device and provide a data message over the wireless communication network using a predefined communication protocol. The data message may comprise the unique identifier corresponding to the transceiver sending the message, as well as the sensor data signal. The plurality of repeaters also have unique identifiers. Each of the plurality of repeaters may be disposed in relation to the plurality of transceivers such that each of the plurality of repeaters is in communication with at least one of the plurality of transceivers via the wireless communication network. Furthermore, each of the plurality of repeaters may be configured to receive the data message from the corresponding transceiver and provide an outgoing data message over the wireless communication network using the predefined communication protocol. The outgoing data message may include the data message received from the corresponding transceiver and the corresponding unique identifier for the repeater.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a block diagram illustrating one of a number of possible embodiments of a automated monitoring system according to the present invention;

FIG. 2 is a block diagram illustrating one of a number of possible embodiments of the transceiver of FIG. 1;

FIG. 3 is a block diagram illustrating one of a number of possible embodiments of the transceiver and sensor of FIG. 1 in combination;

FIG. 4 is a block diagram illustrating one of a number of possible embodiments of the site controller of FIG. 1;

FIG. 5 is a table illustrating an embodiment of a message structure for a communication protocol according to the present invention that may be used for communicating between the site controller and transceivers of FIG. 1.

FIG. 6 is a table illustrating the data section of a downstream message in accordance with the message protocol of FIG. 5;

FIG. 7 is a table illustrating the data section of an upstream message in accordance with the message protocol of FIG. 5; and

FIG. 8 is a block diagram illustrating another embodiment of a control/monitoring system according to the present invention.

### DETAILED DESCRIPTION OF THE PREFERRED EMBODIMENT

Having summarized the invention above, reference is now made in detail to the description of the invention as illustrated in the drawings. While the invention will be described in connection with these drawings, there is no intent to limit it to the embodiment or embodiments disclosed therein. On the contrary, the intent is to cover all alternatives, modifications and equivalents included within the spirit and scope of the invention as defined by the appended claims.

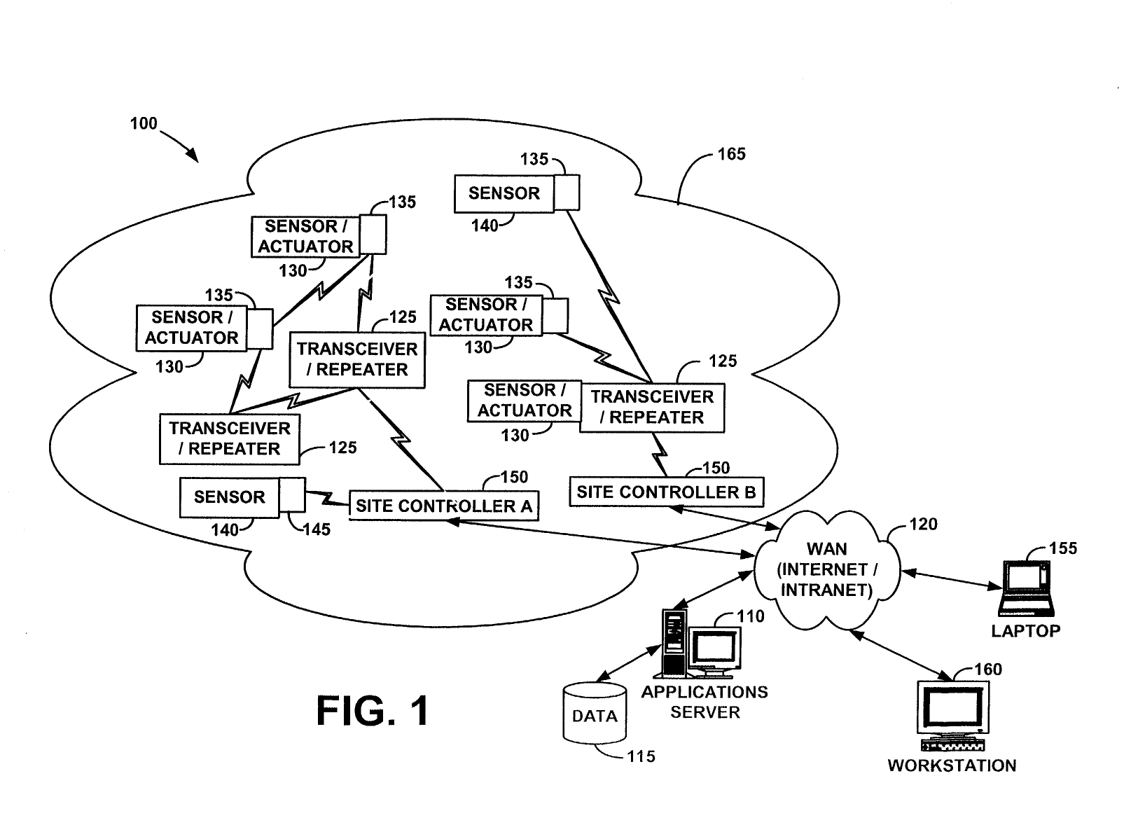

FIG. 1 illustrates a block diagram of one of a number of possible embodiments of an automated monitoring system 100 in accordance with the present invention. The automated monitoring system 100 generally comprises an applications server 110, one or more site controllers 150, and a series of remote devices, such as one or more sensors 140 and sensors/actuators 130. The applications server 110 may communicate with a user via a laptop 155, workstation 160, etc. The site controller 150 and the applications server 110 communicate via a wide area network (WAN) 120 or other suitable communication networks. The site controller 150 communicates with remote devices 130 and 140 via a series of transceivers. A transceiver 135 may be integrated with a sensor 140 and a sensor/actuator 130. Transceivers 135 are preferably wireless RF transceivers that are relatively small in size and that transmit a relatively low power RF signal. As a result, in some applications, the transmission range of a given transceiver 135 may be relatively limited, which can be a desirable characteristic of the automated monitoring system 100. Although the transceivers 135 are depicted without user interfaces such as a keypad (not shown), the transceivers 135 may be configured with user selectable buttons or an alphanumeric keypad (not shown). Often, the transceivers 135 may be electrically interfaced with a sensor/actuator 130 such as a smoke detector, a thermostat, a security system, etc., where external buttons are not needed.

The automated monitoring system 100 may include a plurality of stand-alone transceivers 125. Each of the stand-alone transceivers 125 and each of the integrated transceivers 135 may receive an incoming RF transmission and transmit an outgoing signal. This outgoing signal may be another low power RF transmission signal, a higher power RF transmission signal, or together with alternative embodiments, may be transmitted over a conductive wire, a fiber optic cable, or other transmission media. One of ordinary skill in the art will appreciate that, if an integrated transceiver 135 is located sufficiently close to the site controller 150 such that the outgoing signal of the integratee transceiver may can be received by a site controller 150, the outgoing signal need not be processed and repeated through one of the stand-alone transceivers 125.

Stand-alone transceivers 125 act as repeaters within the automated monitoring system 100. In operation, a stand-alone transceiver 125 receives an incoming message and transmits an outgoing message comprising the incoming message. The stand-alone transceiver 125 allows the automated monitoring system 100 to be geographically larger without any increases in transmission power, sensitivity, etc. In addition, an integrated transceiver 135 may function as both an integrated transceiver and a repeater as described below.

It is significant to note that one or more specific types of RF transceivers may be used with the present invention. For example, one RF transceiver that may be used is the TR1000, manufactured by RF Monolithics, Inc. The TR1000 hybrid transceiver is well suited for short range, wireless data applications where robust operation, small size, low power consumption, and low-cost are desired. All critical RF functions may be performed within a single hybrid semi-conductor chip, thereby simplifying circuit design and accelerating the design-in process. The receiver section of the TR1000 is sensitive and stable. A wide dynamic range log detector, in combination with digital automatic gain control (AGC), provide robust performance in the presence of channel noise or interference. Two stages of surface acoustic wave (SAW) filtering provide excellent receiver out-of-band rejection, which may suppress output harmonics. The transmitter section of the TR1000 may include provisions for both on-off keyed (OOK) and amplitude-shift key (ASK) modulation.

Additional details of the TR1000 transceiver need not be described herein, because the present invention is not limited by the particular choice of transceiver. Indeed, numerous RF transceivers may be implemented in accordance with the teachings of the present invention. Such other transceivers may include other 900 MHz transceivers, as well as transceivers at other frequencies. The transceivers in automated monitoring system 100 may be configured to receive data signals from sensors 140 and sensors/actuators 130, as well as other devices and/or appliances, via other wireless technologies, such as Bluetooth and the 802.11(b) standard adopted by the Institute of Electrical and Electronics Engineers (IEEE), which is hereby incorporated by reference in its entirety. For instance, the transceivers in automated monitoring system 100 may be configured to implement the technology described in “Specification of the Bluetooth System: Specification Volume 1,” Feb. 22, 2001, which is hereby incorporated by reference in its entirety. In addition, infrared, ultrasonic, and other types of wireless transceivers may be employed as one of ordinary skill in the art will appreciate. In this manner, automated monitoring system 100 may be configured to support monitoring and/or controlling of remote devices that employ any type of communication medium. One of ordinary skill in the art will appreciate that each of the transceivers in automated monitoring system 100 and site controller 150 may be configured to support multiple communication protocols. Further details of the TR1000 transceiver may be obtained through data sheets, application notes, design guides (e.g., the “ASH Transceiver Designers Guide”), and other publications known by those skilled in the art.

Site controllers 150 may send and receive remote data transmissions from one or more of the stand-alone transceivers 125 or one or more of the integrated transceivers 135. The site controller 150 may also analyze the transmissions received, convert the transmissions into TCP/IP format, and further communicate the remote data signal transmissions to the applications server 110 via the WAN 120. In this regard, the site controller 150 may communicate information, service requests, control signals, etc. to the integrated transceivers 135 from the applications server 110, the laptop computer 155, and/or the workstation 160 across the WAN 120. The applications server 110 may be further networked with a database 115 to record client specific data. Further information regarding the integration of the invention into the WAN 120 can be found in the commonly assigned U.S. patent application Ser. No. 09/704,150 entitled, “System and Method for Monitoring and Controlling Residential Devices,” and filed Nov. 1, 2000, which is hereby incorporated in its entirety by reference.

As shown in FIG. 1, the automated monitoring system 100 may use two site controllers 150, labeled site controller A and site controller B. While multiple site controllers 150 are not required, the automated monitoring system 100 may include multiple site controllers 150. The site controller B 150 may act as a back-up in case of failure of the site controller A 150. The site controller B 150 may expand the capacity of the automated monitoring system 100.

One of ordinary skill in the art will appreciate that automated monitoring system 100 may be used in a variety of environments. In accordance with a preferred embodiment, automated monitoring system 100 may be employed to monitor and record utility usage by residential and industrial customers, to transfer vehicle diagnostics from an automobile via an RF transceiver integrated with a vehicle diagnostics bus to a local transceiver that further transmits the vehicle information through a site controller to a communication network, to monitor and control an irrigation system, to automate a parking facility, etc. Further information regarding these individual applications may be found in the commonly assigned U.S. patent application Ser. No. 09/704,150, entitled, “System and Method for Monitoring and Controlling Residential Devices,” and filed Nov. 1, 2000, which is hereby incorporated in its entirety by reference.

The integrated transceivers 135 may have substantially identical construction, which may provide a cost-effective implementation. Alternatively, the transceivers (integrated 135 or stand-alone 125) may differ based on particular design needs. Furthermore, a plurality of stand-alone transceivers 125 may be disposed in such a way that adequate RF coverage is provided throughout a coverage area 165. Preferably, the stand-alone transceivers 125 may be geographically placed such that only one stand-alone transceiver 125 will pick up a transmission from a given integrated transceiver 135. As is well known in the art, each transceiver 125 has a known transmission pattern (not shown). Each transceiver 125 may be geographically placed within automated monitoring system 100 such that the transmission patterns overlap to form the coverage area 165 and thereby provide consistent and effective communication throughout automated monitoring system 100.

However, in various embodiments of automated monitoring system 100, transceivers 125 may be arranged such that two or more stand-alone transceivers 125 receive a single transmission. Thus, the site controller 150 may receive multiple versions of the same message from an integrated transceiver 135 but from different stand-alone transceivers 125. The site controller 150 may utilize these multiple identical messages to triangulate or otherwise more particularly assess the location from which the common message is originating. As described below, duplicative transmissions may be ignored or otherwise appropriately handled by including a transmitting device identifier in messages transmitted within automated monitoring system 100.

In one embodiment, the site controller 150 collects, formats, and stores client specific data from each of the integrated transceivers 135 for later retrieval or access by the applications server 110. Because the site controller 150 may be permanently integrated with the WAN 120, the applications server 110 connected to WAN 120 may host application specific software. In this regard, the workstation 160 or the laptop 155 may be used to access the information stored at the applications server 110 through a Web browser or in any other suitable manner. In another embodiment, the applications server 110 may perform the additional functions of hosting application specific control system functions. In a third embodiment, clients may elect, for proprietary reasons, to host control applications on a separate workstation 160 connected to WAN 120. Thus, database 115 and applications server 110 may act solely as a data collection and reporting device with the client workstation 160 generating control signals for the system. Further information may be found in the commonly assigned U.S. patent application Ser. No. 09/704,150 entitled, “System and Method for Monitoring and Controlling Residential Devices,” filed Nov. 1, 2000, hereby incorporated in its entirety by reference.

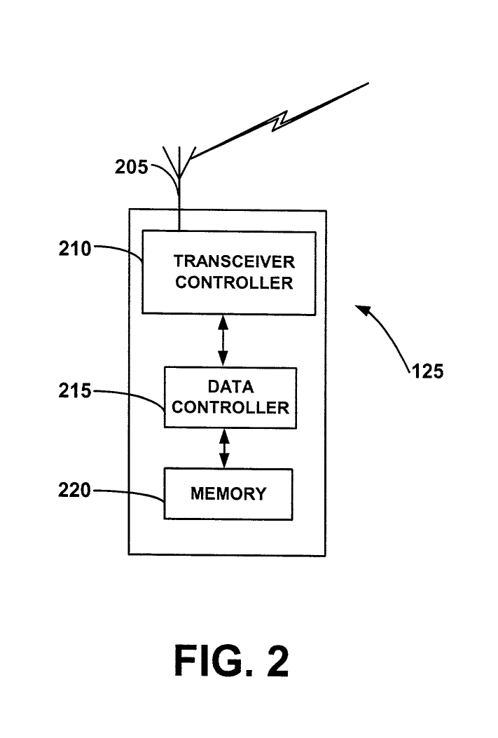

FIG. 2 illustrates one of a number of embodiments of a stand-alone transceiver 125 functioning as a repeater. The repeater 125 receives messages and re-transmits the received messages to the intended recipient. The repeater 125 may comprise an antenna 205, a transceiver controller 210, a data controller 215, and memory 220. The antenna 205 acts as an electromagnetic radiator to transmit and/or receive the radiated RF signals. The antenna 205 may also be any appropriate structure based upon the communication method chosen such as infrared, ultrasound, etc. as would be known to one of ordinary skill in the art. The transceiver controller 210 receives signals from the antenna and demodulates the received signals to reveal the incoming messages. The transceiver controller 210 then outputs the incoming message to the data controller 215. The data controller 215 then evaluates the incoming message and generates an outgoing message related to the incoming message based on data contained within memory 220. Memory 220 stores information such as the transceiver identifier and various look-up tables as discussed below.

The transceiver identifier stored in memory 220 uniquely identifies the transceiver. One of ordinary skill in the art will appreciate that the unique address may be varied depending upon individual system needs. In one embodiment, the unique address is a six-byte address. In alternate embodiments, the address may be shorter or longer in length depending upon memory availability, system size, etc.

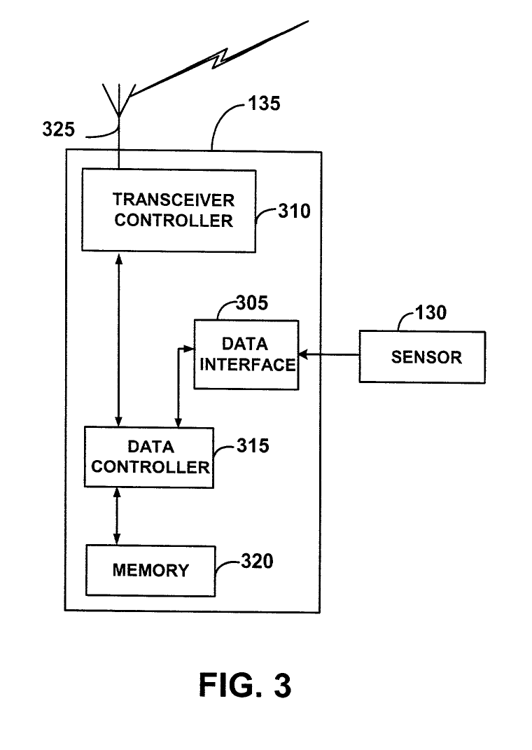

Reference is now made to FIG. 3, which is a block diagram illustrating a transceiver 135 that may be integrated with a sensor 130. As stated above, the characteristics of sensor 130 may vary depending on the environment in which automated monitoring system 100 is implemented. For example, the sensor 130 may be a two-state device such as a smoke alarm, a thermometer, a utility meter, a personal security system controller, or any other sensor. Regardless the specific characteristics of sensor 130, transceiver 135 may include a data interface 305 configured to receive and/or transmit signal to sensor 130. If the signal output from the sensor 130 is an analog signal, the data interface 305 may include an analog-to-digital converter (not shown) to convert the signals. Alternatively, where transceiver 135 and sensor 130 communicate using digital signals, transceiver 135 may include a digital interface (not shown) that communicates with the data interface 305 and the sensor 130.

As illustrated in FIG. 3, the sensor 130 may be in communication with the transceiver 135. Transceiver 135 may comprise an RF transceiver controller 310, a data interface 305, a data controller 315, a memory 320, and an antenna 325. A data signal forwarded from the sensor 130 may be received by the data interface 305. In those situations where the data interface 305 has received an analog data signal, the data interface 305 may be configured to convert the analog signal into a digital signal before forwarding a digital representation of the data signal to the data controller 315. In one embodiment, each transceiver 135 may be configured with a memory 320 that stores a unique transceiver identifier that identifies the RF transceiver 135.

Transceivers 135 that function in automated monitoring system 100 as both a repeater and an integrated transceiver have two unique addresses. One address indicates messages intended for the repeater; the second address indicates messages for the sensor 130. Data controller 315 evaluates the incoming message to determine which address the message contains, which function is desired, and acts accordingly.

In operation, the RF transceiver 135 receives an incoming message via antenna 325. The transceiver controller 310 receives the incoming message, modifies the received signal, and passes the modified signal onto the data controller 315. The data controller 315 evaluates the message to determine the intended recipient.

If the intended recipient is the integrated transceiver 135, the data controller 315 then prepares the appropriate response as discussed below. This response may include data from the sensor 130. If the intended recipient is the repeater, the data controller 315 then prepares the message to be repeated onto the intended recipient according to the message protocol discussed below.

Of course, additional and/or alternative configurations may also be provided by a similarly configured transceiver 135. For example, a similar configuration may be provided for a transceiver 135 that is integrated into, for example, a carbon monoxide detector, a door position sensor, etc. Alternatively, system parameters that vary across a range of values may be transmitted by transceiver 135 as long as data interface 305 and data controller 315 are configured to apply a specific code that is consistent with the input from sensor 130. Automated monitoring system 100 may enable the target parameter to be monitored. The transceiver 135 may be further integrated with an actuator (not shown). This provides the ability to remotely control systems such as HVAC systems, lighting systems, etc. via the applications server 110 (FIG. 1). Further information regarding use of actuators in automated monitoring system 100 may be found in commonly assigned U.S. patent application Ser. No. 09/811,076, entitled “System and Method for Monitoring and Controlling Remote Devices,” and filed Mar. 16, 2001, which is hereby incorporated in its entirety by reference.

One of ordinary skill in the art will appreciate that the various communication devices in automated monitoring system 100 may be configured with a number of optional power supply configurations. For example, a personal mobile transceiver may be powered by a replaceable battery. Similarly, a repeater may be powered by a replaceable battery that may be supplemented and/or periodically charged via a solar panel. These power supply circuits, therefore, may differ between communication device depending upon the devices being monitored, the related actuators to be controlled, the environment, and the quality of service required. In the case of a transceiver acting as both a repeater and a remote monitoring device, the transceiver may be independently powered so as not to drain the sensor or actuator. Those skilled in the art will appreciate how to meet the power requirements of the various communication devices. As a result, it is not necessary to further describe a power supply suitable for each communication device and each application in order to appreciate the concepts and teachings of the present invention.

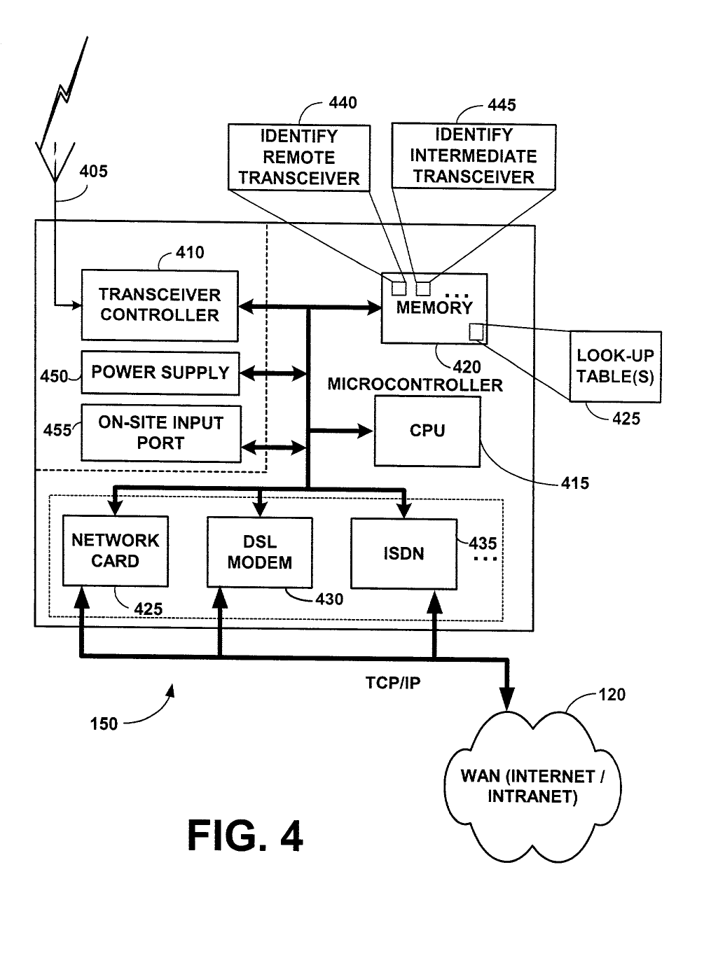

Having illustrated and described the operation of the various combinations of communication devices with the sensor 140 and sensor/actuators 130 (FIG. 1), reference is now made to FIG. 4, which is a block diagram further illustrating one embodiment of a site controller 150. A site controller 150 may comprise an antenna 405, a transceiver controller 410, a central processing unit (CPU) 415, memory 420, a network interface device, such as a network card 425, a digital subscriber line (DSL) modem 430, an integrated services digital network (ISDN) interface card 435, as well as other components not illustrated in FIG. 4, which may be configured to enable a TCP/IP connection to the WAN 120 (FIG. 1). Site controller 150 may also include a power supply 450 for powering the site controller 150. The power supply 450 may be one of many known power supplies. In addition, the site controller 150 may include an on-site input port 455, which allows a technician to communicate directly with site controller 150. Further information regarding the function, operation, and architecture of the site controller 150 may be found in commonly assigned U.S. Patent Application “System and Method for Controlling Communication Between a Host Computer and Communication Devices Associated with Remote Devices in an Automated Monitoring System,” (Serial No. 09/xxx,xxx) which is hereby incorporated in its entirety by reference.

The transceiver controller 410 may be configured to receive incoming transmissions via the antenna 405. Each of the incoming transmissions are consistently formatted in the message protocol as described below. The site controller 150 may be configured such that the memory 420 includes a look-up table 425 configured for identifying the various remote and intermediate communication devices used in generating and transmitting the received data transmission. As illustrated in FIG. 4, site controller 150 may include an “Identify Remote Transceiver” memory sector 440 and and “Identify Intermediate Transceiver” memory sector 445. Programmed or recognized codes within memory 425 may also be provided and configured for controlling the operation of a CPU 415 to carry out the various functions that are orchestrated and/or controlled by the site controller 150 For example, memory 420 may include program code for controlling the operation of the CPU 415 to evaluate an incoming data packet to determine what action needs to be taken. In this regard, one or more look-up tables 425 may also be stored within the memory 420 to assist in this process. Furthermore, the memory 420 may be configured with program code configured to identify a remote transceiver or identify an intermediate RF transceiver. Function codes and RF transmitter and/or RF transceiver identifiers may all be stored with associated information within the look-up tables 425.

Thus, one look-up table 425 may be provided to associate transceiver identifications with a particular user. Another look-up table 425 may be used to associate function codes associated with the message protocol. For example, a look-up table 425 may include a unique code designating various functions, such as test, temperature, smoke alarm active, security system breach, etc. In connection with the lookup table(s) 425, the memory 420 may also include a plurality of code segments that are executed by the CPU 415, which may in large part control operation of the site controller 150. For example, a first data packet segment may be provided to access a first lookup table to determine the identity of the transceiver that transmitted the received message. A second code segment may be provided to access a second lookup table to determine the proximate location of the transceiver that generated the message. A third code segment may be provided to identify the content of the message transmitted (not shown). Namely, is it a fire alarm, a security alarm, an emergency request by a person, a temperature control setting, etc. In accordance with the present invention, additional, fewer, or different code segments may be provided to carry out different functional operations and data signal transfers.

The site controller 150 may also include one or more network interface devices to facilitate via WAN 120. For example, the site controller 150 may include a network card 425, which may allow the site controller 150 to communicate across a local area network to a network server. This network server may function as a backup site controller 150 to the WAN 120. Alternatively, the site controller 150 may contain a DSL modem 430, which may be configured to provide a link to a remote computing system by way of the public switched telephone network (PSTN). In yet another embodiment, the site controller 150 may include an ISDN card 435 configured to communicate via an ISDN connection with a remote system. One of ordinary skill in the art will appreciate that various other communication interfaces may be provided to serve as primary and/or backup links to the WAN 120 (FIG. 1) or to local area networks that might serve to permit local monitoring of the status of the site controller 150 and for data packet control.

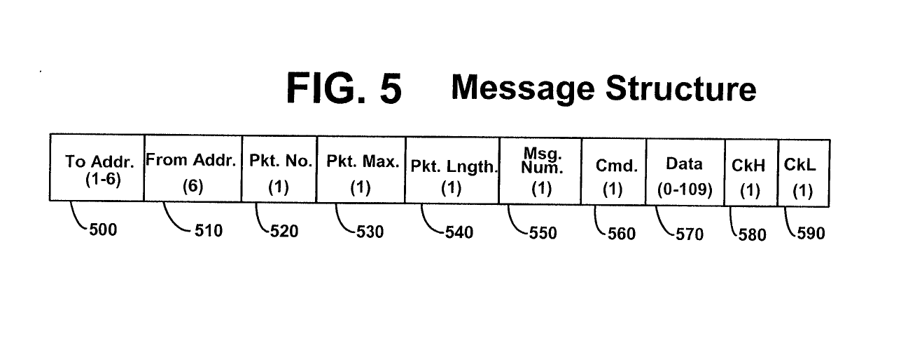

Communication between the site controller 150 and the communication devices within coverage area 165 may be implemented using a data packet protocol according to the present invention. FIG. 5 sets forth one embodiment of a message structure for the data packet protocol of the present invention. Messages transmitted within the automated monitoring system 100 may consist of a “to” address 500, a “from” address 510, a packet number 520, a number of packets in a transmission 530, a packet length 540, a message number 550, a command number 560, data 570 (if applicable), and a check sum error detectors (CKH 580 and CKL 590).

The “to” address 500 indicates the intended recipient of the packet. This address can be scalable from one to six bytes based upon the size and complexity of automated monitoring system 100. By way of example, the “to” address 500 may indicate a general message to all transceivers, to only the repeaters, or to a single integrated transceiver. In a six byte “to” address 500, the first byte indicates the transceiver type—to all transceivers, to some transceivers, or a specific transceiver. The second byte may be the identification base, and bytes three through six may be used for the unique transceiver address (either stand-alone or integrated). The “to” address 500 may be scalable from one byte to six bytes depending upon the intended recipient(s).

The “from” address 510 identifies the transceiver originating the transmission and may be a six-byte unique address. The “from” address 510 may be the address of the site controller 150 (FIG. 1) when the site controller 150 (FIG. 1) requests data, or this may be the address of the integrated transceiver responding to a request for information from the site controller 150 (FIG. 1).

The packet number 520, the packet maximum 530, and the packet length 540 may be used to concatenate messages that are greater than a predetermined length. The packet maximum 530 indicates the number of packets in the message. The packet number 520 may be used to indicate a packet sequence number for a multiple-packet message.

The message number 550 may be assigned by the site controller 150. Messages originating from the site controller 150 may be assigned an even number, while responses to the site controller 150 may have a message number equal to the original message number plus one. Thus, the site controller 150 may increments the message number 550 by two for each new originating message. This may enable the site controller 150 to coordinate the incoming responses to the appropriate command message.

The command number 560 may designate a specific data request from the receiving device. One of ordinary skill in the art will appreciate that, depending on the specific implementation of automate monitoring system 100, the types of commands may differ. In one embodiment, there may be two types of commands: device specific and non-device specific. Device specific commands may control a specific device such as a data request or a change in current actuator settings. Commands that are not device specific may include, but are not limited to, a ping, an acknowledge, a non-acknowledgement, downstream repeat, upstream repeat, read status, emergency message, and a request for general data to name a few. General data may include a software version number, the number of power failures, the number of resets, etc.

The data field 570 may contain data as requested by a specific command. The requested data may be any value. By way of example, test data can preferably be encoded in ASCII (American Standard Code for Information Interchange) or other known encoding systems as known in the art. The data field 570 of a single packet may be scalable up to a predetermined length. When the requested data exceeds the predetermined length, the data controller of transceiver 135 may divide the data into an appropriate number of sections and concatenates the series of packets for one message using the packet identifiers as discussed above.

While specific byte lengths for sections of the message are being set forth, it would be obvious to one of ordinary skill in the art to vary the byte lengths based upon system needs. Less complex systems, etc. could use smaller sized sections, whereas more complex systems could increase the byte lengths.

Checksum fields 580 and 590 may be used to detect errors in the transmissions. In one embodiment, any error can be detected via cyclic redundancy check sum methodology. This methodology treats the message as a large binary number and divides the binary number by a generating polynomial (such as CRC-16). The remainder of this division is then sent with the message as the checksum. The receiver then calculates a checksum using the same methodology and compares the two checksums. If the checksums do not match, the packet or message will be ignored. While this error detection methodology is preferred, one of ordinary skill in the art will appreciate that other error detection systems may be implemented.

As stated above, automated monitoring system 100 may employ wireless and/or wired communication technologies for communication between site controller 150 and the various communication devices. In one embodiment, communication between site controller 150 and the communication devices may be implemented via an RF link at a basic rate of 4,800 bits per second (bps) and a data rate of 2400 bps. All the data may be encoded in the Manchester format such that a high to low transition at the bit center point represents a logic zero and a low to high transition represents a logic one. One of ordinary skill in the art will appreciate that other RF formats may be used depending upon design needs. By way of example, a quadature phase shift encoding method may be used, thereby enabling automated monitoring system 100 to communicate via hexadecimal instead of binary.

While the message indicates specific byte length for each section, only the order of the specific information within the message is constant. The byte position number in individual transmissions may vary because of the scalability of the “to” address 500, the command byte 560, and the scalability of the data 570.

The message may further include a preface and a postscript (not shown). The preface and postscripts are not part of the message body but rather serve to synchronize the control system and to frame each packet of the message. The packet begins with the preface and ends with a postscript. The preface may be a series of twenty-four logic ones followed by two bit times of high voltage with no transition. The first byte of the packet can then follow immediately. The postscript may be a transition of the transmit data line from a high voltage to a low voltage, if necessary. It may be less desirable to not leave the transmit data line high after the message is sent. It would be obvious to one of ordinary skill in the art to modify the preface and the postscript as necessary based on specific design needs.

Returning to FIG. 1, the repeater 125 acts as a communications bridge between a remote device and the site controller 150 when the remote device cannot reliably communicate directly with the site controller 150. In this manner, the repeater 125 may communicate in two or more modes: normal, emergency, etc.

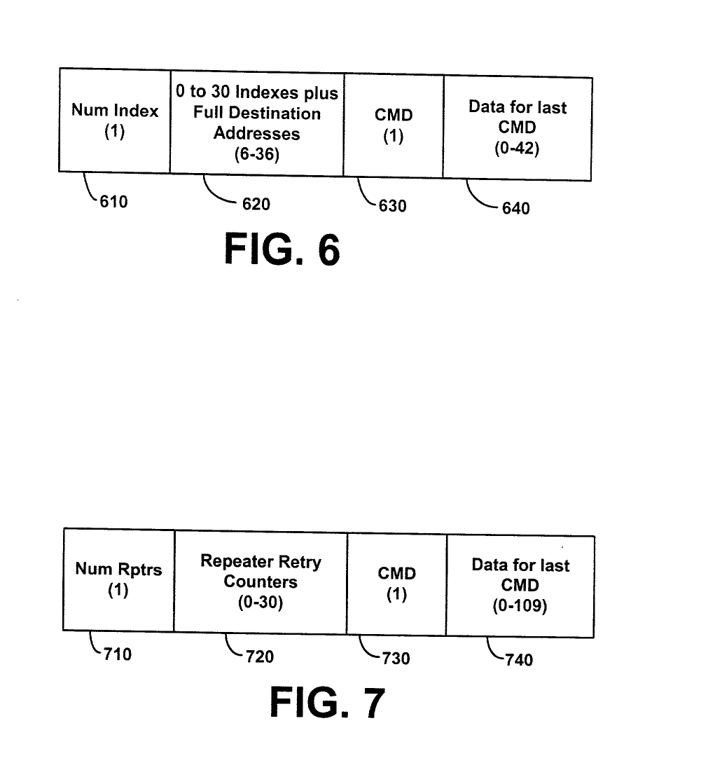

For example, during normal communication, the repeater 125 may have two functions: repeating messages (including repeating upstream messages) and repeating downstream messages. Upstream messages are transmissions to another repeater 125 or remote device. Downstream messages are transmissions to another repeater 125 or site controller 150. Responding to common messages involves taking the appropriate action and sending a response to the site controller 150. The repeater 125 may modify the message depending upon the stream direction. An exemplary format for the data field 570 for a downstream repeated message is set forth in FIG. 6. For instance, the data field 570 may have a “Num Index” 610, which may identify the number of indexes being sent with the downstream repeat. The indexes 620 may contain the downstream path including the intended recipient address. The “CMD” field 630 may identify the particular command for the intended receiving device. The “Data for last CMD” field 640 may include either an index table of downstream addresses or upstream addresses.

FIG. 7 sets forth an example of the structure for the data field 570 of an upstream message. The “number of repeaters” 710 may indicate the number of upstream repeaters. The “Repeater Retry Counters” 720 may indicate the number of retries by each repeater in the upstream. The “CMD” field 730 may indicate the command sent to the intended remote device. The “Data for last CMD” 740 may indicate the data in response to the original command from the intended remote device.

Examples of commands that are sent directly from the site controller 150 to the repeater 125 include load upstream addresses. This command causes the repeater 125 to store the addresses to which the repeater 125 sends messages when communicating upstream. The loading of the upstream addresses also initiates a transceiver functioning as a repeater 125. The response to a load command may be a status message that is sent to the site controller 150.

Another example of a communication mode is emergency mode. In this mode, emergency messages are automatically transmitted upstream regardless of what other actions may be taking place. Unlike normal communications, emergency messages are sent unsolicited from the integrated transceiver 135 to the site controller 150.

During all modes of communication, each of the communication devices may expect a response message to all messages sent. There may be at least two acknowledgements: a positive acknowledgement, a negative acknowledgement, etc. The positive acknowledgement may be sent whenever a message is received and understood. A negative acknowledgement may be sent whenever the message is not received and understood correctly or whenever an expected message is not received. A negative acknowledgment may be followed by a predetermined number of retries

Automated monitoring system 100 may be adapted to monitor and apply control signals in an unlimited number of applications. By way of example only, communication devices according to the present invention may be adapted for use with pay type publicly located telephones, cable television set converter boxes, personal security systems, electric utility meters, as well as, for use with a variety of other appliances and devices.

In a geographic area appropriately networked with permanently located repeaters 125, personal transceivers (not shown) may be used to monitor and control personnel access and egress from specific rooms or portions thereof within a controlled facility. Personal transceivers may be further configured to transfer personal information to public emergency response personnel, to transfer personal billing information to vending machines, or to monitor individuals within an assisted living community.

Transceivers according to the present invention may also be integrated to monitor and control a host of industrial and business applications as well. By way of example only, building automation systems, fire control systems, alarm systems. industrial trash compactors, and building elevators may be monitored and controlled with such devices. In addition, courier drop boxes, time clock systems, automated teller machines, self-service copy machines, and other self-service devices may be monitored and controlled as appropriate. By way of further example, a number of environment variables that require monitoring may be integrated with the system of the present invention to permit remote monitoring and control. For instance, light levels in the area adjacent to automated teller machines must meet minimum federal standards. Also, the water volume transferred by water treatment plant pumps, smokestack emissions from a coal burning power plant or a coke fueled steel plant oven may be remotely monitored.

The transceivers using the packet message protocol of the present invention may be further integrated with a voice-band transceiver. As a result, when a person presses, for example, the emergency button on his/her transmitter, medical personnel, staff members, or others may respond by communicating via two-way radio with the party in distress. In this regard, each transceiver may be equipped with a microphone and a speaker that would allow a person to communication information such as their present emergency situation, their specific location, etc.

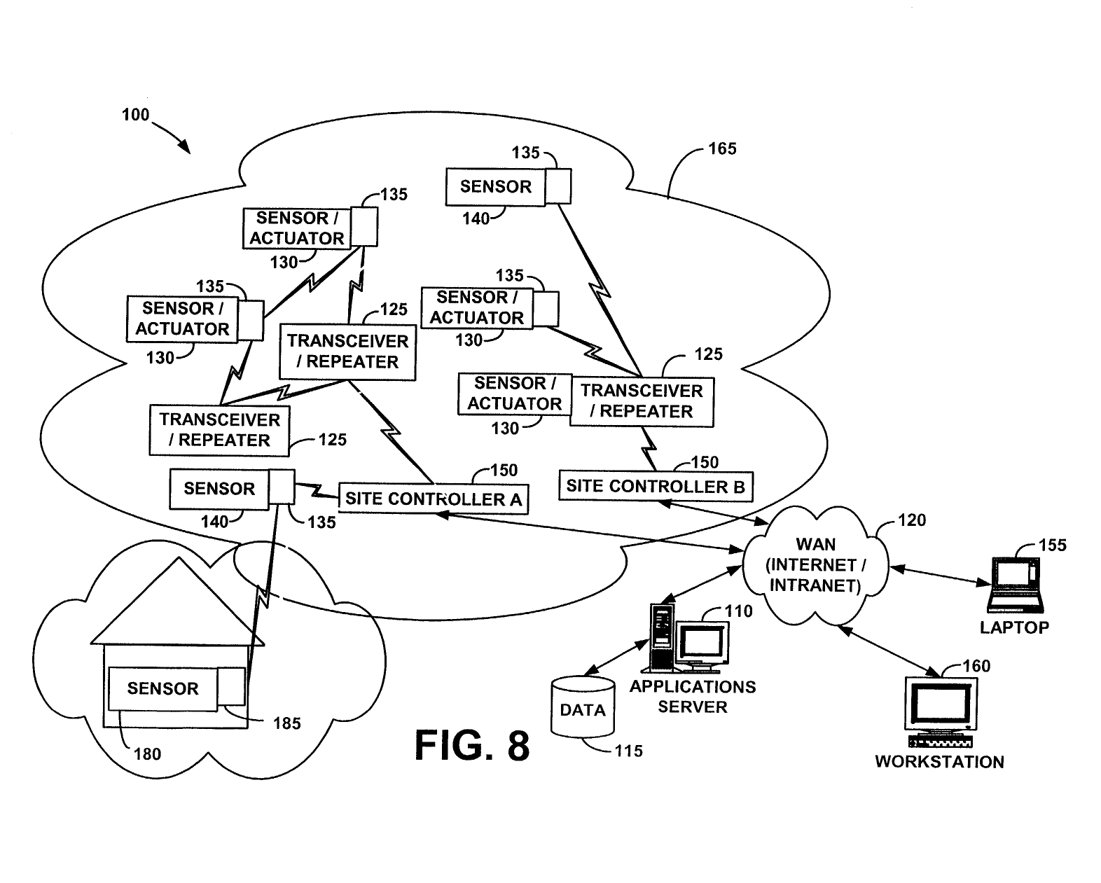

FIG. 8 sets forth another embodiment of an automated monitoring system 100 according to the present invention. Automated monitoring system 100 of FIG. 1 is shown with an additional sensor 180 and transceiver 185. The additional sensor 180 and transceiver 185 are shown to be communicating with, but outside of, the coverage area 165. In this example, the additional sensor 180 and transceiver 185 may be placed outside of the original control system. In order to communicate, the coverage area of transceiver 185 need only overlap the coverage area 165. By way of example only, the original installation may be an automated monitoring system 100 that monitors electricity usage via the utility meters in an apartment complex. Later a neighbor in a single family residence nearby the apartment complex may remotely monitor and control their thermostat by installing a sensor/actuator transceiver according to the present invention. The transceiver 185 then communicates with the site controller 150 of the apartment complex. If necessary, repeaters (not shown) may also be installed to communicate between the transceiver 185 and the apartment complex site controller 150. Without having the cost of the site controller 150, the neighbor may enjoy the benefits of the control system.

The foregoing description has been presented for purposes of illustration and description. It is not intended to be exhaustive or to limit the invention to the precise embodiments disclosed. Obvious modifications or variations are possible in light of the above teachings. When the transceiver is permanently integrated into an alarm sensor other stationary device within a system, then the control system server and/or site controller could be configured to identify the transceiver location by the transceiver identification number alone. It will be appreciated that, in embodiments that do not utilize stand-alone transceivers, the transceivers will be configured to transmit at a higher RF power level in order to effectively communicate with the site controller 150.

It will be appreciated by those skilled in the art that the information transmitted and received by the wireless transceivers of the present invention may be further integrated with other data transmission protocols for transmission across telecommunications and computer networks. In addition, it should be further appreciated that telecommunications and computer networks can function as a transmission path between the networked wireless transceivers, the site controller 150, and the applications server 110.

What is claimed is:

1. A system for interconnecting a plurality of remote devices to a site controller in an automated monitoring system via a wireless communication network, the automated monitoring system configured for monitoring and controlling the plurality of remote devices using a host computer adapted to communicate with the site controller via a communication network, the system comprising;
a plurality of transceivers having unique identifiers, each of the plurality of transceivers configured for communication with one of the plurality of remote devices and configured to receive a sensor data signal from the corresponding remote device and provide a data message over the wireless communication network using a predefined communication protocol, the data message comprising the corresponding unique identifier and sensor data signal; and
a plurality of repeaters having unique identifiers, each of the plurality of repeaters disposed in relation to the plurality of transceivers such that each of the plurality of repeaters is in communication with at least one of the plurality of transceivers via the wireless communication network and configured to receive the data message from the corresponding transceiver and provide an outgoing data message over the wireless communication network using the predefined communication protocol, the outgoing data message including the data message and the corresponding unique identifier for the repeater.

2. The system of claim 1, wherein the wireless communication network involves radio frequency communication.

3. The system of claim 1, wherein the wireless communication network involves low power radio frequency communication.

4. The system of claim 1, wherein the predefined communication protocol comprises a data packet comprising:
a receiver address identifying the receiver of the data packet;
a sender address identifying the sender of the data packet; and
a command indicator specifying a predefined command code;

5. The system of claim 1, wherein each of the plurality of transceivers and repeaters are configured to implement a plurality predefined communication protocols.

6. The system of claim 1, wherein the plurality of transceivers and the plurality of repeaters are further configured to receive a command message via the wireless communication network

7. The system of claim 1, wherein one of the plurality of transceivers further comprises one of the plurality of repeaters.

8. The system of claim 4, wherein the data packet further comprises a data payload and a checksum field for performing a redundancy check.

9. The system of claim 8, wherein the data packet further comprises:
a packet length indicator which indicates a total number of bytes in the current packet;
a total packet indicator which indicates the total number of packets in the current message; and
a current packet indicator which identifies the current packet; and a message number identifying the current message.

10. The system of claim 9, wherein the data packet further comprises a preface and a postscript.

11. An automated monitoring system for monitoring and controlling a plurality of remote devices, comprising:
a plurality of transceivers having unique identifiers, each of the plurality of transceivers configured for communication with one of the plurality of remote devices and configured to receive a sensor data signal from the corresponding remote device and provide a data message over a wireless communication network using a predefined communication protocol, the data message comprising the corresponding unique identifier and sensor data signal;
a plurality of repeaters having unique identifiers, each of the plurality of repeaters disposed in relation to the plurality of transceivers such that each of the plurality of repeaters is in communication with at least one of the plurality of transceivers via the wireless communication network and configured to receive the data message from the corresponding transceiver and provide an outgoing data message over the wireless communication network using the predefined communication protocol, the outgoing data message including the data message and the corresponding unique identifier for the repeater;
a site controller configured to communicate with the plurality of repeaters and the plurality of transceivers via the wireless communication network using the predefined communication protocol;
a host computer configured to communicate with the site controller via a communications network.

12. The system of claim 11, wherein the wireless communication network involves radio frequency communication.

13. The system of claim 11, wherein the communication network is a wide are a network.

14. The system of claim 11, wherein the predefined communication protocol comprises a data packet comprising:
a receiver address identifying the receiver of the data packet;
a sender address identifying the sender of the data packet; and
a command indicator specifying a predefined command code;

15. The system of claim 11, wherein the plurality of transceivers and the plurality of repeaters are further configured to receive a command message via the wireless communication network and provide a response message associated with the corresponding remote device.

16. The system of claim 11, wherein one of the plurality of transceivers further comprises one of the plurality of repeaters.

17. The system of claim 14, wherein the data packet further comprises a data payload and a checksum field for performing a redundancy check.

18. The system of claim 17, wherein the data packet further comprises:
a packet length indicator which indicates a total number of bytes in the current packet;
a total packet indicator which indicates the total number of packets in the current message; and
a current packet indicator which identifies the current packet; and a message number identifying the current message.

19. The system of claim 18, wherein the data packet further comprises a preface and a postscript.
